(19) United States
(12) Patent Application Publication
(10) Pub. No.: US 2016/0268611 A1
(43) Pub. Date: Sep. 15, 2016

(54) TITANIUM SEPARATOR MATERIAL FOR FUEL CELLS, AND METHOD FOR PRODUCING TITANIUM SEPARATOR MATERIAL FOR FUEL CELLS

(71) Applicant: KABUSHIKI KAISHA KOBE SEIKO SHO(KOBE STEEL, LTD.), Kobe-shi, Hyogo (JP)

(72) Inventors: Jun SUZUKI, Hyogo (JP); Toshiki SATO, Hyogo (JP)

(73) Assignee: KABUSHIKI KAISHA KOBE SEIKO SHO (KOBE STEEL, LTD.), Kobe-shi, Hyogo (JP)

(21) Appl. No.: 15/033,780

(22) PCT Filed: Oct. 20, 2014
(86) PCT No.: PCT/JP2014/077848

§ 371 Date: May 2, 2016

(30) Foreign Application Priority Data
Nov. 11, 2013 (JP) 2013-233075
Nov. 11, 2013 (JP) 2013-233076

(51) Int. Cl. H01M 8/0228; H01M 8/1069; H01M 8/0221; H01M 8/026; H01M 8/0206

(52) U.S. Cl. CPC H01M 8/0228; H01M 8/026; H01M 8/0206; H01M 8/0221; H01M 8/1069

(57) ABSTRACT

A fuel cell separator material made of titanium containing a carbon-based conductive layer formed on a surface of a base material. The base material contains pure titanium or a titanium alloy. The carbon-based conductive layer has a two-layer structure. In the carbon-based conductive layer, a layer on a side closer to the base material is a carbon layer and a layer on a side farther from the base material is a conductive resin layer. The carbon layer contains graphite and the carbon layer has a coverage of 40% or more. The conductive resin layer contains a carbon powder and a predetermined resin.

### TECHNICAL FIELD

The present invention relates to a fuel cell separator material made of titanium used for fuel cells and a production method of a fuel cell separator material made of titanium.

### BACKGROUND ART

Unlike a primary battery such as dry battery and a secondary battery such as lead storage battery, a fuel cell, which is capable of continuously generating electric power by continuously supplying a fuel such as hydrogen and an oxidizing agent such as oxygen, has high power generation efficiency, is little affected by the size of system scale and generates little noise and vibration. Therefore, a fuel cell is expected as an energy source covering a variety of applications and scales. A fuel cell has been developed specifically as a polymer electrolyte fuel cell (PEFC), an alkaline fuel cell (AFC), a phosphoric acid fuel cell (RUC), a molten carbonate fuel cell (MCFC), a solid oxide fuel cell (SOFC), a biofuel cell, etc. Among others, development of a polymer electrolyte fuel cell is promoted for use in fuel cell vehicles, domestic cogeneration systems and mobile devices such as cellular phone and personal computer.

The polymer electrolyte fuel cell (hereinafter, referred to as “fuel cell”) is constructed by stacking a plurality of unit cells with a separator (also called a bipolar plate) therebetween, the separator having a groove working out to a flow path for gas (e.g., hydrogen and oxygen), where the unit cell is obtained by putting a polymer electrolyte membrane between an anode and a cathode.

The separator is also a component for leading a current generated in the fuel cell to the outside and therefore, a material that is low in the contact resistance (i.e., occurrence of a voltage drop due to an interfacial phenomenon between the electrode and the separator surface) is applied thereto. In addition, high corrosion resistance is required of the separator, because the inside of the fuel cell is in an acidic atmosphere at a pH of approximately from 2 to 4. Furthermore, it is also required to have a property of maintaining the above-described low contact resistance (conductivity) for a long period of time during use in the acidic atmosphere.

As a material satisfying these requirements, carbon is attracting attention, and application of carbon to the separator is studied. Specifically, studies are being made on a carbon separator produced by the machining of a graphite powder compact or formed from a mixed compact of graphite and a resin (for example, Patent Documents 1 to 3), or a separator where, on a base material composed of a metal material such as titanium and stainless steel, carbon particles are deposited (for example, Patent Documents 4 to 7) or a carbon film is deposited by a chemical vapor deposition (CVD) method, etc.

### PRIOR ART LITERATURES

### Patent Documents

Patent Document 1: JP-A-10-3931 (the term “JP-A” as used herein means an “unexamined published Japanese patent application”)

Patent Document 2: Japanese Patent No. 4,075,343

Patent Document 3: JP-A-2005-162550

Patent Document 4: Japanese Patent No. 3,904,690

Patent Document 5: Japanese Patent No. 3,904,696

Patent Document 6: Japanese Patent No. 4,886,885

Patent Document 7: Japanese Patent No. 5,108,986

### SUMMARY OF THE INVENTION

### Problems that the Invention is to Solve

In the fuel cell separator, materials are sometimes frictioned with each other in handling during processing into the separator or during incorporation into a cell, posing a concern for generation of damage, etc. in the conductive layer (carbon-based conductive layer) formed on the separator surface. In addition, the surface of the separator after the incorporation into a cell is put into contact with carbon paper constituting a gas diffusion layer while being pressurized and particularly, when used for in-vehicle applications, a friction may be caused between the conductive layer formed on the separator surface and the carbon paper due to vibration accompanying the running. On this occasion, if the conductive layer is easily abraded, the electrical resistance between the separator and the carbon paper is increased as the operating time becomes longer, and the power generation performance of the fuel cell is reduced.

Therefore, abrasion resistance as well as conductivity and durability (conductive durability: a property of maintaining the conductivity for a long period of time) are required of the separator material for the fuel cell separator.

However, the techniques disclosed in Patent Documents 1 to 7 are not a technique taking into account the above-described circumstances and cannot sufficiently respond to the need regarding abrasion resistance, etc., and there is room for improvement.

The present invention has been made in consideration of the above-described problem, and an object of the present invention is to provide a fuel cell separator material made of titanium, which is excellent in the conductivity and durability and also excellent in the abrasion resistance, and a production method of a fuel cell separator material made of titanium.

### Means for Solving the Problems

As a result of intensive studies, the present inventors have found that when the carbon-based conductive layer (carbon layer and conductive resin layer) having a two-layer structure is formed on the base material surface of a fuel cell separator material made of titanium and not only the coverage of the carbon layer is set to be equal to or more than a predetermined value but also the resin of the conductive resin layer is specified to be a predetermined one, the conductivity and durability are excellent and the abrasion resistance is also excellent. The present invention has thus been created.

In addition, as a result of intensive studies, the present inventors have also found that when a press-forming step is performed after a carbon layer forming step and a conductive resin layer forming step, or a conductive resin layer forming step is performed after a carbon layer forming step and a press-forming step, the likelihood of separation of a carbon-based conductive layer (carbon layer and conductive resin layer) in handling after press-forming can be reduced and hi conductivity can be maintained for a long period of time.

In order to attain the above-described object, the fuel cell separator material made of titanium according to the present invention is a fuel cell separator material made of titanium, having a carbon-based conductive layer formed on a surface of a base material composed of pure titanium or a titanium alloy, in which the carbon-based conductive layer has a two-layer structure, and in the carbon-based conductive layer, a layer on a side closer to the base material is a carbon layer and a layer on a side farther from the base material is a conductive resin layer; the carbon layer contains graphite and the carbon layer has a coverage of 40% or more; and the conductive resin layer contains a carbon powder and a resin and the resin is one or more resins selected from an acrylic resin, a polyester resin, an alkyd resin, a urethane resin, a silicone resin, a phenol resin, an epoxy resin, and a fluororesin.

In this way, the fuel cell separator material made of titanium according to the present invention has a carbon-based conductive layer having a two-layer structure of a carbon layer and a conductive resin layer, so that the carbon-based conductive layer can enhance the conductivity and durability of the separator material. In addition, the conductive resin layer functions as a protective film, so that the abrasion resistance can be enhanced compared with a separator material having a conductive layer composed of only one layer.

In the fuel cell separator material made of titanium according to the present invention, the carbon layer preferably has the coverage of 40% or more and 80% or less.

As above, in the fuel cell separator material made of titanium according to the present invention, the carbon layer on the base material has the coverage of equal to or less than a predetermined value, so that reduction in the abrasion resistance or adhesiveness, and of course in the conductivity, can be suppressed even after applying a press-forming process during production of a separator material.

In the fuel cell separator material made of titanium according to the present invention, an interlayer containing titanium carbide is preferably formed between the base material and the carbon layer.

As above, in the fuel cell separator material made of titanium according to the present invention, an interlayer is formed between the base material and the carbon layer, so that the adhesiveness between the base material and the carbon layer can be enhanced. As a result, the likelihood of separation of the carbon-based conductive layer containing a carbon layer can be reduced.

In the fuel cell separator material made of titanium according to the present invention, the conductive resin layer preferably has a thickness of from 0.1 to 20 μm.

As above, in the fuel cell separator material made of titanium according to the present invention, the thickness of the conductive resin layer is specified to a predetermined range, so that the effect of enhancing the abrasion resistance is ensured and a great increase in the electrical resistance value can be prevented, making it possible to provide a suitable embodiment as a separator material.

A method for producing a fuel cell separator material made of titanium according to the present invention includes a carbon layer forming step of forming a carbon layer containing graphite on a surface of a base material composed of pure titanium or a titanium alloy, and a conductive resin layer forming step of, after the carbon layer forming step, forming a conductive resin layer containing a carbon powder and a resin on/above the base material having formed thereon the carbon layer, in which the carbon layer has a coverage of 40% or more and the resin of the conductive resin layer is one or more resins selected from an acrylic resin, a polyester resin, an alkyd resin, a urethane resin, a silicone resin, a phenol resin, an epoxy resin, and a fluororesin.

As above, the method for producing a fuel cell separator material made of titanium according to the present invention includes a carbon layer forming step and a conductive resin layer forming step, so that a carbon-based conductive layer having a two-layer structure of a carbon layer and a conductive resin layer can be formed on a base material. As a result, a fuel cell separator material made of titanium, where the conductivity and durability are enhanced by the carbon-based conductive layer, can be produced. In addition, the conductive resin layer functions as a protective film, so that a fuel cell separator material made of titanium, where the abrasion resistance is enhanced compared with a separator material having a conductive layer composed of only one layer, can be produced.

In the method for producing a fuel cell separator material made of titanium according to the present invention, the carbon layer preferably has the coverage of 40% or more and 80% or less.

As above, in the method for producing a fuel cell separator material made of titanium according to the present invention, the carbon layer on the base material has the coverage of equal to or less than a predetermined value, so that a fuel cell separator material made of titanium, where reduction in the abrasion resistance or adhesiveness, and of course in the conductivity, is suppressed even after applying a press-forming process during production of a separator material, can be produced.

The method for producing a fuel cell separator material made of titanium according to the present invention preferably includes a heat treatment step of heat-treating the base material at 200 to 550° C., after the conductive resin layer forming step.

As above, the method for producing a fuel cell separator material made of titanium according to the present invention includes a heat treatment step after the conductive resin layer forming step, so that the resin on the outermost surface of the conductive resin layer can be partially decomposed and removed and in turn, an increase in the contact resistance due to a high resin ratio of the conductive resin layer can be suppressed. As a result, a fuel cell separator material made of titanium, where the contact resistance is more reduced, can be produced.

The method for producing a fuel cell separator material made of titanium according to the present invention preferably includes a heat treatment step of heat-treating the base material at 300 to 850° C. under a non-oxidizing atmosphere, between the carbon layer forming step and the conductive resin layer forming step.

As above, the method for producing a fuel cell separator material made of titanium according to the present invention includes a heat treatment step between the carbon layer forming step and the conductive resin layer forming step, so that an interlayer can be formed between the base material and the carbon layer and the adhesiveness between the base material and the carbon layer can be enhanced. As a result, a fuel cell separator material made of titanium, where the likelihood of separation of the carbon-based conductive layer containing a carbon layer is reduced, can be produced.

A method for producing a fuel cell separator material made of titanium according to the present invention includes a carbon layer forming step of forming a carbon layer containing graphite on a surface of a base material composed of pure titanium or a titanium alloy, a conductive resin layer forming step of, after the carbon layer forming step, forming a conductive resin layer containing a carbon powder and a resin on/above the base material having formed thereon the carbon layer, and a press-forming step of, after the conductive resin layer forming step, press-forming the base material on/above which the carbon layer and the conductive resin layer have been formed, to form a gas flow path, in which the carbon layer has a coverage of 40% or more and the resin of the conductive resin layer is one or more resins selected from an acrylic resin, a polyester resin, an alkyd resin, a urethane resin, a silicone resin, a phenol resin, an epoxy resin, and a fluororesin.

As above, in the method for producing a fuel cell separator material made of titanium according to the present invention, a press-forming step is performed after a carbon layer forming step and a conductive resin layer forming step, and thereby the conductive resin layer plays a role of a protective layer during press-forming, so that separation/falling off of the carbon layer during press-forming can be avoided. In addition, two layers of carbon layer and conductive resin layer formed on the base material enhance the conductivity and durability (conductive durability: a property of maintaining the conductivity for a long period of time) and, the conductive resin layer reduces the likelihood of separation of the carbon-based conductive layer (carbon layer and conductive resin layer) during handling after press-forming.

In the method for producing a fuel cell separator material made of titanium according to the present invention, the carbon layer preferably has the coverage of 40% or more and 80% or less.

As above, in the method for producing a fuel cell separator material made of titanium according to the present invention, the carbon layer on the base material has the coverage of equal to or less than a predetermined value, so that a fuel cell separator material made of titanium, where reduction in the abrasion resistance or adhesiveness, and of course in the conductivity, is suppressed even after applying a press-forming process during production of a separator material, can be produced.

The method for producing a fuel cell separator material made of titanium according to the present invention preferably includes a heat treatment step of heat-treating the base material at 200 to 550° C., after the press-forming step.

As above, in the method for producing a fuel cell separator material made of titanium according to the present invention, a heat treatment step is performed after the press-forming step, so that the resin on the outermost surface of the conductive resin layer can be partially decomposed and removed and in turn, an increase in the contact resistance due to a high resin ratio of the conductive resin layer can be suppressed. As a result, a fuel cell separator material made of titanium, where the contact resistance is more reduced, can be produced.

The method for producing a fuel cell separator material made of titanium according to the present invention preferably includes a heat treatment step of heat-treating the base material at 300 to 850° C. under a non-oxidizing atmosphere, between the carbon layer forming step and the conductive resin layer forming step.

As above, the method for producing a fuel cell separator material made of titanium according to the present invention includes a heat treatment step between the carbon layer forming step and the conductive resin layer forming step, so that an interlayer containing titanium carbide can be formed between the base material and the carbon layer. As a result, a fuel cell separator material made of titanium, where the adhesiveness between the base material and the carbon layer is enhanced and, the likelihood of separation of the carbon layer and the conductive resin layer is reduced, can be produced.

A method for producing a fuel cell separator material made of titanium according to the present invention includes a carbon layer forming step of forming a carbon layer containing graphite on a surface of a base material composed of pure titanium or a titanium alloy, a press-forming step of, after the carbon layer forming step, press-forming the base material having formed thereon the carbon layer to form a gas flow path, and a conductive resin layer forming step of, after the press-forming step, forming a conductive resin layer containing a carbon powder and a resin on/above the base material having formed thereon the carbon layer and having press-formed, in which the carbon layer has a coverage of 40% or more and the resin of the conductive resin layer is one or more resins selected from an acrylic resin, a polyester resin, an alkyd resin, a urethane resin, a silicone resin, a phenol resin, an epoxy resin, and a fluororesin.

As above, in the method for producing a fuel cell separator material made of titanium according to the present invention, a conductive resin layer forming step is performed after a press-forming step. Even if the carbon layer cannot follow the deformation of the base material during press-forming and cracking of the carbon layer may be caused, since a conductive resin layer is thereafter formed as being laminated thereon, this layer can cover and protect the cracked portion of the carbon layer. In addition, two layers of carbon layer and conductive resin layer formed on the base material enhance the conductivity and durability (conductive durability: a property of maintaining the conductivity for a long period of time) and, the conductive resin layer reduces the likelihood of separation of the carbon-based conductive layer (carbon layer and conductive resin layer) during handling after press-forming.

In the method for producing a fuel cell separator material made of titanium according to the present invention, the carbon layer preferably has the coverage of 40% or more and 80% or less.

As above, in the method for producing a fuel cell separator material made of titanium according to the present invention, the carbon layer on the base material has the coverage of equal to or less than a predetermined value, so that a fuel cell separator material made of titanium, where reduction in the abrasion resistance or adhesiveness, and of course in the conductivity, is suppressed even after applying a press-forming process during production of a separator material, can be produced.

The method for producing a fuel cell separator material made of titanium according to the present invention preferably includes a heat treatment step of heat-treating the base material at 200 to 550° C., after the conductive resin layer forming step.

As above, the method for producing a fuel cell separator material made of titanium according to the present invention includes a heat treatment step after the conductive resin layer forming step, so that the resin on the outermost surface of the conductive resin layer can be partially decomposed and removed and in turn, an increase in the contact resistance due to a high resin ratio of the conductive resin layer can be suppressed. As a result, a fuel cell separator material made of titanium, where the contact resistance is more reduced, can be produced.

The method for producing a fuel cell separator material made of titanium according to the present invention preferably includes a heat treatment step of heat-treating the base material at 300 to 850° C. under a non-oxidizing atmosphere, between the carbon layer forming step and the press-forming step.

As above, the method for producing a fuel cell separator material made of titanium according to the present invention includes a heat treatment step between the carbon layer forming step and the press-forming step, so that an interlayer containing titanium carbide can be formed between the base material and the carbon layer. As a result, a fuel cell separator material made of titanium, where the adhesiveness between the base material and the carbon layer is enhanced and, the likelihood of separation of the carbon layer and the conductive resin layer is reduced, can be produced.

### Advantage of the Invention

The fuel cell separator material made of titanium according to the present invention has a carbon-based conductive layer having a two-layer structure of a carbon layer and a conductive resin layer, so that the carbon-based conductive layer can enhance the conductivity and durability of the separator material. In addition, the conductive resin layer functions as a protective film, so that the abrasion resistance can be enhanced compared with a separator material having a conductive layer composed of only one layer.

Therefore, the fuel cell separator material made of titanium according to the present invention is excellent in the conductivity and durability (conductive durability: a property of maintaining the conductivity for a long period of time) and also excellent in the abrasion resistance.

The method for producing a fuel cell separator material made of titanium according to the present invention includes a carbon layer forming step and a conductive resin layer forming step, so that a carbon-based conductive layer having a two-layer structure of a carbon layer and a conductive resin layer can be formed on a base material. As a result, a fuel cell separator material made of titanium, where the conductivity and durability are enhanced by the carbon-based conductive layer, can be produced. In addition, the conductive resin layer functions as a protective film, so that a fuel cell separator material made of titanium, where the abrasion resistance is enhanced compared with a separator material having a conductive layer composed of only one layer, can be produced.

Therefore, according to the method for producing a fuel cell separator material made of titanium of the present invention, a fuel cell separator material made of titanium, which is excellent in the conductivity and durability (conductive durability: a property of maintaining the conductivity for a long period of time) and also excellent in the abrasion resistance, can be produced.

### BRIEF DESCRIPTION OF THE DRAWINGS

FIG. 1 A schematic cross-sectional view of the fuel cell separator material made of titanium according to an embodiment of the present invention.

FIG. 2 A schematic cross-sectional view of the fuel cell separator material made of titanium according to another embodiment of the present invention.

FIG. 3 A schematic cross-sectional view of the fuel cell separator material made of titanium according to still another embodiment of the present invention.

FIG. 4 A flowchart of the method for producing a fuel cell separator material made of titanium according to an embodiment of the present invention.

FIG. 5 A flowchart of the method for producing a fuel cell separator material made of titanium according to another embodiment of the present invention.

FIG. 6 A flowchart of the method for producing a fuel cell separator material made of titanium according to still another embodiment of the present invention.

FIG. 7 A diagrammatic view of the contact resistance measuring apparatus used in the evaluations of conductivity, durability and abrasion resistance in Examples 1 and 2.

FIG. 8 A diagrammatic view of the contact resistance measuring apparatus used in the evaluations of conductivity, durability and abrasion resistance in Examples 3 and 4.

FIG. 9 A schematic cross-sectional view of the fuel cell separator according to Examples of the present invention.

### MODE FOR CARRYING OUT THE INVENTION

The embodiments of the fuel cell separator material made of titanium (hereinafter, sometimes referred to as a separator material) according to the present invention and the production method of the separator material are described in detail below.

### <<Fuel Cell Separator Material Made of Titanium>>

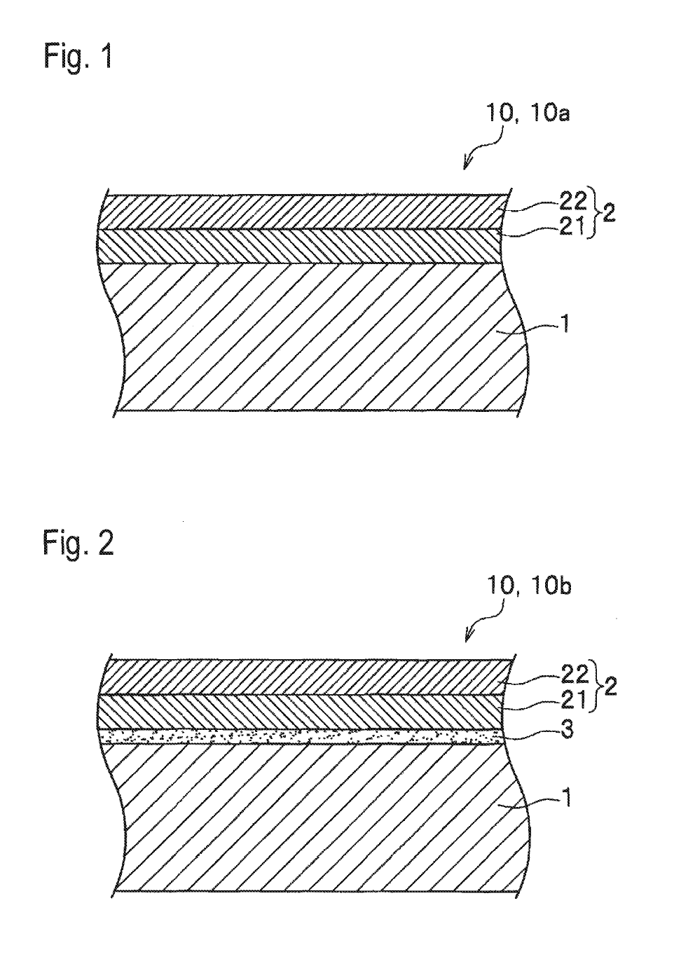

As illustrated in FIG. 1, a separator material 10 (10a) according to the embodiment includes a base material 1 composed of pure titanium or a titanium alloy, and a carbon-based conductive layer 2 formed on the surface (one surface or both surfaces) of the base material 1. As illustrated in FIG. 2, a separator material 10 (10b) according to the embodiment may have an interlayer 3 between the base material 1 and the carbon-based conductive layer 2.

In FIGS. 1 and 2, a separator material 10 where a carbon-based conductive layer 2 (and an interlayer 3) is formed on only one surface of a base material 1, is illustrated, but a carbon-based conductive layer 2 (and an interlayer 3) may be formed on both surfaces of a base material 1.

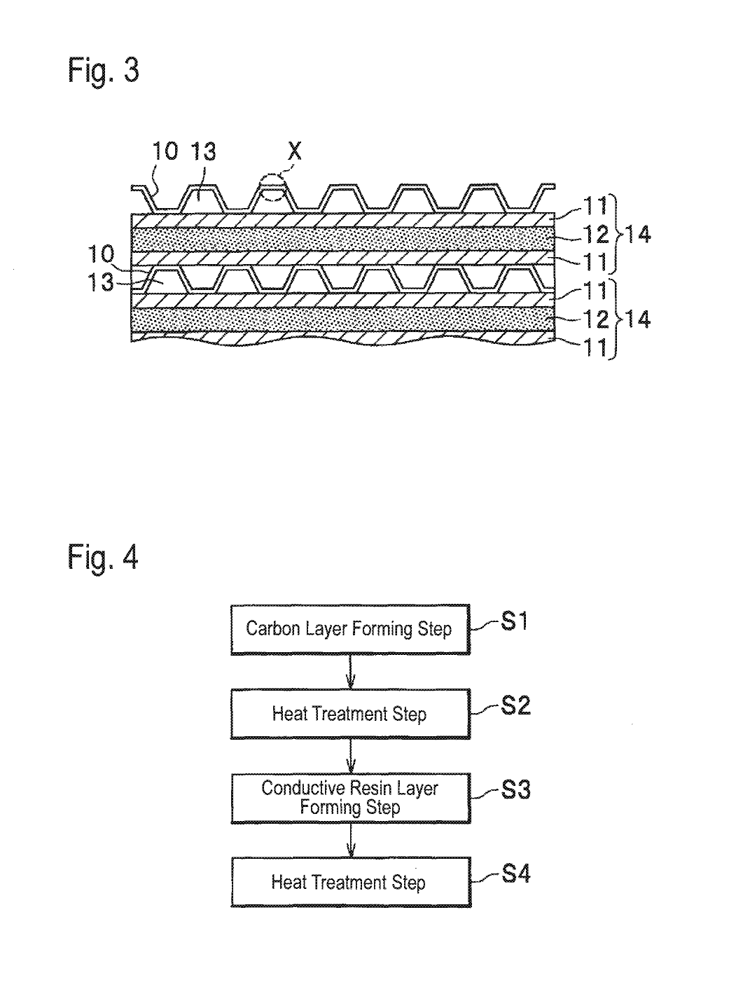

The separator material 10 may take on a plate-like shape and, as illustrated in FIG. 3, may take on a concavo-convex shape in a cross-sectional view due to formation of a gas flow path 13 on the surface. The separator material 10 is provided between a cell 14 and a cell 14 each constructed by stacking gas diffusion layers 11, 11 and an electrolyte membrane 12. Here, the cross-sectional view enlarging the X portion of FIG. 3 corresponds to the cross-sectional view of FIG. 1 or 2.

The base material 1, the carbon-based conductive layer 2 and the interlayer 3 of the separator material 10 are described below.

### <Base Material>

As the base material of the separator material according to the embodiment, a metal base material is preferably used in view of processability necessary to form a groove working out to a gas flow path, in view of gas barrier property, and in view of conductivity and thermal conductivity. Among others, pure titanium or a titanium alloy is lightweight, excellent in corrosion resistance and excellent also in the strength and toughness and therefore, is very preferred.

A base material manufactured by a conventionally known method, for example, a method of melting and casting pure titanium or a titanium alloy to make an ingot, followed by hot-rolling and then cold-rolling may be used. The base material is preferably finished by annealing, but the finished state thereof does not matter and may be any finished state of, for example, “annealing+pickling finish”, “vacuum heat treatment finish”, and “bright annealing finish”.

The base material is not limited to pure titanium or titanium alloy of a specific composition, but in the case of using a base material composed of pure titanium or a titanium alloy, from the standpoint of facilitating cold rolling of a titanium material (matrix) (capability of performing cold rolling of a total rolling reduction of 35% or more without process annealing) or ensuring press-formability after that, applicable are, for example, pure titanium of Class 1 to Class 4 prescribed in JIS H 4600, or a Ti alloy such as Ti—Al, Ti—Ta, Ti-6Al-4V, and Ti—Pd. Among these, pure titanium which is particularly suitable for thinning is preferred. Specifically, preferred is one having a composition of O: 1,500 ppm or less (more preferably 1,000 ppm or less), Fe: 1,500 ppm or less (more preferably 1,000 ppm or less), C: 800 ppm or less, N: 300 ppm or less, and H: 130 ppm or less, with the remainder being Ti and unavoidable impurities, and a cold-rolled sheet of JIS Class 1 may be used. By using a titanium base material, the separator material is enhanced in the strength and roughness and is lightweight and therefore, use in automotive applications is particularly facilitated.

The sheet thickness of the base material is preferably from 0.05 to 1.0 mm. This is because, if the sheet thickness is less than 0.05 mm, the strength required of the base material cannot be ensured, and on the other hand, if it exceeds 1.0 mm, fine processing of a gas flow path for passing hydrogen or air becomes difficult.

### <Carbon-Based Conductive Layer>

The carbon-based conductive layer has a two-layer structure. As illustrated in FIGS. 1 and 2, the carbon-based conductive layer 2 consists of a carbon layer 21 formed on the side closer to the base material 1 and a conductive resin layer 22 formed on the side farther from the base material 1.

### (Carbon Layer)

The carbon layer is configured to contain graphite and provided to cover the base material. The graphite contained in the carbon layer has high crystallinity and excellent conductivity and therefore, not only imparts conductivity to the separator material but also imparts durability of maintaining the conductivity even in the fuel cell internal environment (high temperature and acidic atmosphere).

Here, the graphite contained in the carbon layer is preferably configured to contain at least one of flaky graphite powder, scaly graphite powder, expanded graphite powder, and pyrolytic graphite powder.

Unlike the later-described conductive resin layer, the carbon layer is substantially free of a resin (binder resin). The “substantially free of a resin” as used herein indicates that in the carbon layer, the mass ratio (mass of resin solid content in carbon layer/mass of carbon powder in carbon layer) between the resin solid component and the graphite is 0.1 or less.

The carbon layer preferably covers the entire surface of the base material in view of conductivity but need not necessarily cover the entire surface, and in order to ensure conductivity and corrosion resistance, it may cover 40% or more of the surface. If the coverage is less than 40%, the conductivity is insufficient, and the properties required of a separator material are not satisfied. A preferred range of the coverage is 45% or more and more preferably 50% or more.

Here, assuming that a press-forming process is applied to the separator material in production of a separator, material elongation occurs due to the processing. Here, if the coverage of the carbon layer on the base material exceeds 80%, the carbon layer may not be able to follow the elongation of the base material in a portion subject to large elongation during processing, and separation may occur between the base material and the carbon layer to reduce the abrasion resistance or adhesiveness of the carbon-based conductive layer (2 layers). On the other hand, when the coverage of the carbon layer on the base material is 80% or less, reduction in the abrasion resistance or adhesiveness of the carbon-based conductive layer can be suppressed even in a portion where elongation of the base material occurred due to processing.

Accordingly, in consideration of satisfying not only the conductivity but also both abrasion resistance and adhesiveness of the carbon-based conductive layer after the press-forming process, the lower limit of the coverage of the carbon layer is preferably 40% or more, more preferably 45% or more and particularly preferably 50% or more, and the upper limit is preferably 80% or less, more preferably 75% or less and particularly preferably 70% or less.

Here, the coverage of the carbon layer can be determined by observing the separator surface having formed thereon a carbon layer by means of an optical microscope or a scanning microscope. This is, for example, a method where a region of 550×400 μm on the separator surface having formed thereon a carbon layer is observed at an observation magnitude of 200 times by using a scanning electron microscope, a reflected electron image thereof is taken, the reflected electron image is then binarized by image processing of dividing it into a portion covered by the carbon layer and a portion uncovered by the carbon layer to expose the base material, and the area percentage occupied by the carbon layer is calculated to determine the coverage. In the case where a conductive resin layer is already formed on the carbon layer, the method above may be performed after dissolving and removing the conductive resin layer with an organic solvent or an alkali solution.

The deposition amount of the carbon layer is not particularly limited but is preferably from 2 to 1,000 μg/cm². This is because, if it is less than 2 μg/cm², the conductivity and corrosion resistance cannot be ensured due to the small deposition amount, and if it exceeds 1,000 μg/cm², not only the effect as to conductivity and corrosion resistance is saturated but also the processability is reduced. The deposition amount of the carbon layer is more preferably 5 μg/cm² or more and still more preferably 10 μg/cm² or more.

Here, the coverage and deposition amount of the carbon layer can be controlled by the amount of a graphite powder applied onto the base material in the later-described graphite powder coating step.

### (Conductive Resin Layer)

The conductive resin layer is configured to contain a carbon powder and a resin and acts as a protective film having both conductivity and abrasion resistance.

The carbon powder contained in the conductive resin layer is preferably a carbon black powder, an acetylene black powder, a graphite powder, or a mixed powder thereof. These powders are excellent in the conductivity and corrosion resistance and at the same time, are an inexpensive material and therefore, they are advantageous from a production viewpoint.

The resin (binder resin) for forming the conductive resin layer is one or more resins selected from an acrylic resin, a polyester resin, an alkyd resin, a urethane resin, a silicone resin, a phenol resin, an epoxy resin, and a fluororesin. In the case of containing two or more resins, the resins may be reacted with each other or may be merely mixed. However, the resin is preferably a resin capable of being formed into a coating material. Furthermore, it is more preferable to be selected from a urethane resin, a silicone resin, a phenol resin, an epoxy resin, and a fluororesin, which are stable even under a high-temperature (80 to 100° C.) and acidic (pH of 2 to 4) atmosphere inside a fuel battery.

The conductive resin layer is formed by applying a conductive resin coating material prepared by mixing a resin and a carbon powder, and the mass ratio (mass of resin solid content in coating material/mass of carbon powder in coating material) between the resin solid component and the carbon powder in the coating material is preferably from 0.5 to 10. If this mass ratio is less than 0.5, the ratio of the resin component in the conductive resin layer as formed is small and therefore the strength as a layer is lacked, failing in achieving the target abrasion resistance. On the other hand, if the mass ratio above exceeds 10, the ratio of the carbon powder in the conductive resin layer as formed is small, and therefore the electrical resistance as a layer is increased, which is not preferred in view of properties of the separator material. A more preferred range of the mass ratio above is from 0.8 to 8.

The conductive resin layer preferably has a thickness of from 0.1 to 20 μm. If the thickness of the conductive resin layer is less than 0.1 μm, the conductive resin layer is ruptured by slight friction, and the abrasion resistance becomes insufficient. On the other hand, if the thickness of the conductive resin layer exceeds 20 μm, the electrical resistance as a layer is increased, which is not preferred in view of properties of the separator material. A more preferred thickness of the conductive resin layer is from 0.3 to 19 μm.

### (Relationship Between Carbon Layer and Conductive Resin Layer)

After the formation of the conductive resin layer on the carbon layer, it is very preferable when the graphite powder added to the conductive resin layer is in a state of slightly protruding from the layer, because that portion works out to a good conductive path and in turn, the electrical resistance of the conductive resin layer is reduced.

As described above, the coverage of the carbon layer need not be necessarily 100% and may be 40% or more. In the case where the coverage of the carbon layer is less than 100%, the carbon layer surface partially has a portion in which the surface of the titanium or titanium alloy as the base material is exposed, and this portion is in a state of the conductive resin layer being formed directly on the base material. In other words, it is in a state in which a portion where a carbon-based conductive layer of two layers is formed and a portion where only one layer of a conductive resin layer is formed on the base material are mixed. The conductivity may be obtained with one layer of a conductive resin layer, but particularly good conductivity is achieved in a portion where a carbon-based conductive layer of two layers is formed, and that portion works out to a good conductive path. More specifically, in the present invention, the carbon-based conductive layer has a two-layer structure, whereby even macroscopically adequate conductivity and durability are obtained.

The coverage of the conductive resin layer is preferably 100% but may be 70% or more so as to ensure the abrasion resistance and conductivity.

Here, the coverage of the conductive resin layer can be determined by observing the separator surface having formed thereon a conductive resin layer by means of an optical microscope or a scanning microscope. This is, for example, a method where a region of 550×400 μm on the separator surface having formed thereon a conductive resin layer is observed at an observation magnitude of 200 times by using a scanning electron microscope, a reflected electron image thereof is taken, the reflected electron image is then binarized by image processing of dividing it into a portion covered by the conductive resin layer and a portion uncovered by the conductive resin layer to expose the base material (or the carbon layer), and the area percentage occupied by the conductive resin layer is calculated to determine the coverage.

As described above, as for the coverage of the carbon layer on the base material, when the coverage of the carbon layer on the base material is 80% or less, in other words, when a portion allowing the conductive resin layer to be formed in direct contact with the base material is present at an area percentage of 20% or more, reduction in the abrasion resistance or adhesiveness of the carbon-based conductive layer is suppressed even in a portion where elongation of the base material occurred due to a press-forming process.

Accordingly, in order to satisfy all of the conductivity of a separator produced by the press-forming process of the separator material and the abrasion resistance and adhesiveness of the carbon-based conductive layer, the lower limit of the coverage of the carbon layer on the base material is preferably 40% or more, more preferably 45% or more and particularly preferably 50% or more, and the upper limit is preferably 80% or less, more preferably 75% or less and particularly preferably 70% or less.

### <Interlayer>

As illustrated in FIG. 2, an interlayer 3 of the separator material 10 according to the embodiment is formed at the interface between the base material 1 and the carbon layer 21. The interlayer contains titanium carbide (TiC) produced by mutual diffusion and reaction of C and Ti at the interface between the base material and the carbon layer and may further contain carbon-dissolved titanium (C-dissolved Ti).

Titanium carbide has conductivity and therefore, the electrical resistance at the interface between the base material and the carbon layer is reduced. For this reason, when the separator material has an interlayer containing titanium carbide, the conductivity thereof is more enhanced. In addition, since the interlayer containing titanium carbide is formed by the reaction of the base material and the carbon layer, the adhesiveness between the base material and the carbon layer is improved.

The interlayer is, as described later, formed by performing a heat treatment at a predetermined temperature under a non-oxidizing atmosphere and therefore, in another aspect, is formed by modification of a natural oxide film present on the base material surface. In turn, the separator material having an interlayer formed at the interface between the base material and the carbon layer is configured to allow for substantially no existence of a natural oxide film at the interface, unlike a separator material where an interlayer is not formed at the interface. Accordingly, the separator material having an interlayer formed at the interface between the base material and the carbon layer can avoid reduction in the contact resistance due to a natural oxide film and, as described above, is very effective in enhancing the conductivity.

### <<Production Method of Fuel Cell Separator Material Made of Titanium>>

The method for producing a fuel cell separator material made of titanium according to the present invention is described below.

As illustrated in FIG. 4, the method for producing a separator material according to the present invention includes a carbon layer forming step S1 and a conductive resin layer forming step S3. The method for producing a separator material according to the present invention preferably contains a heat treatment step S2 between the carbon layer forming step S1 and the conductive resin layer forming step S3, preferably contains a heat treatment step S4 after the conductive resin layer forming step S3, and may contain a base material production step before the carbon layer forming step S1.

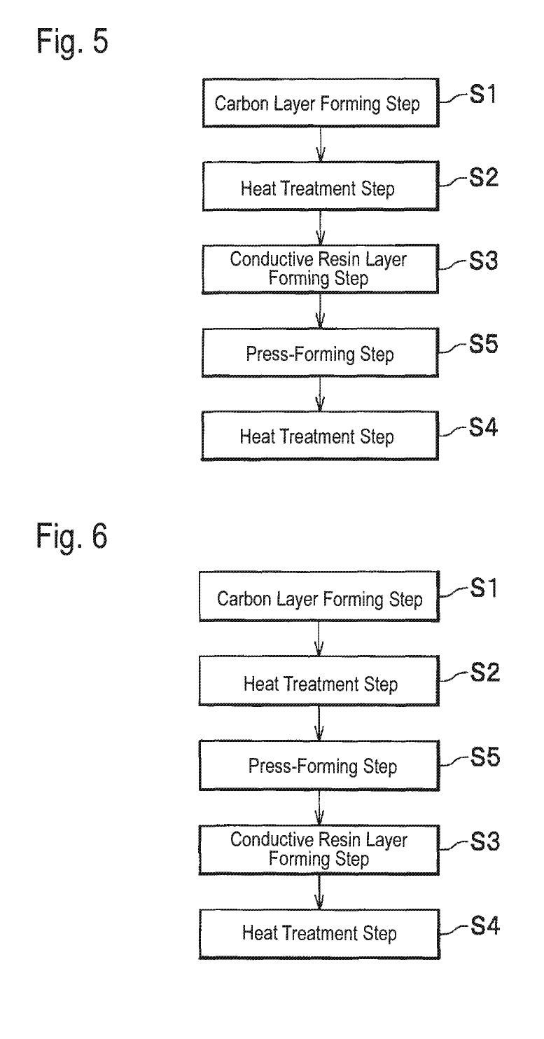

In the case of producing a separator material having been subjected to press-forming, as illustrated in FIGS. 5 and 6, the method for producing a separator material according to the present invention includes a carbon layer forming step S1, a conductive resin layer forming step S3, and a press-forming step S5. The method for producing a separator material according to the present invention preferably includes a heat treatment step S2 after the carbon layer forming step S1 and preferably includes a heat treatment step S4 after the press-forming step S5 (or the conductive resin layer forming step S3). It may contain a base material production step before the carbon layer forming step S1.

Each step is described in detail below.

### <Base Material Production Step>

The base material production step is a step of producing a sheet (strip) material by a known method where the above-described pure titanium or titanium alloy is cast, hot-rolled and, if desired, with intervention such as annealing/pickling treatment, rolled by cold rolling to a desired thickness. The finishing by annealing after the cold rolling may or may not be performed, but in the case of performing a press-forming step in production of the separator material, annealing is preferably performed after the cold rolling so as to ensure processability required in the press-forming process. In addition, pickling after the cold rolling (+after the annealing) may or may not be performed.

### <Carbon Layer Forming Step>

The carbon layer forming step S1 is a step of forming a carbon layer containing graphite on the base material surface.

In the carbon layer forming step S1, first, the surface (one surface or both surfaces) of the base material is coated with a graphite powder (graphite powder coating step). The coating method is not particularly limited, and a graphite powder may be, in the as-is powder state, deposited directly on the base material, or a slurry prepared by dispersing a graphite powder in an aqueous solution of methyl cellulose, etc. or in a coating material containing a binder such as resin may be applied onto the base material surface.

As the graphite powder applied onto the base material surface, one having a diameter of 0.5 to 100.0 μm is preferably used. If the diameter is less than 0.5 μm, the force when pressing the powder against the base material in the later-described rolling step is small, making the adhesion to the base material difficult. On the other hand, if the diameter exceeds 100.0 μm, it can be hardly deposited on the base material surface in the graphite powder coating step and the later-described pressure-bonding step.

The method for applying a slurry having dispersed therein a graphite powder onto the base material is not particularly limited, but the base material may be coated with the slurry by using a bar coater, a roll coater, a gravure coater, a dip coater, a spray coater, etc.

The method for depositing a graphite powder on the base material is not limited to the method above and may also be conducted by the following method. For example, a method where a graphite powder-containing film produced by kneading a graphite powder and a resin is attached onto the base material, a method where a graphite powder is hit into the base material surface by shot blasting and thereby carried on the base material surface, or the like may be considered.

In the carbon layer forming step S1, after the coating with a graphite powder, cold rolling is applied so as to pressure-bond the graphite powder to the base material surface (pressure-bonding step). Through the pressure-bonding step, the graphite powder is pressure-bonded as a carbon layer to the base material surface. Since the carbon powder deposited on the base material surface also plays a role of a lubricant, a lubricant need not be used in applying cold rolling. After rolling, the graphite powder is not in a particle state but in the state of being deposited as a thin layer on the base material and covering the base material surface.

In order to pressure-bond the carbon layer to the base material with good adhesiveness in the pressure-bonding step, rolling is preferably applied at a total rolling reduction of 0.1% or more.

The rolling reduction is a value calculated from a change in the material thickness, including the carbon layer, between before and after cold rolling and is calculated according to “rolling reduction=(t0−t1)/t0×100” (t0: the initial material thickness after graphite powder coating step, t1: the material thickness after rolling).

### <Heat Treatment Step>

The heat treatment step S2 is a step of heat-treating the base material having formed thereon a carbon layer under a non-oxidizing atmosphere. More specifically, the heat treatment step S2 is a step of performing a heat treatment under a non-oxidizing atmosphere after the pressure-bonding step in the carbon layer forming step S1, for forming, at the interface of the base material and the carbon layer, the interlayer containing titanium carbide, the interlayer being formed by the reaction of the base material and the carbon layer. The base material is annealed by the heat treatment step S2, and the processability in press-forming process can also be ensured.

The heat treatment temperature range in the heat treatment step S2 is preferably from 300 to 850° C. If the heat treatment temperature is less than 300° C., the reaction between graphite (carbon layer) and the base material is less likely to occur, and the adhesiveness can be hardly enhanced. On the other hand, if the heat treatment temperature exceeds 850° C., the base material (titanium) may undergo phase transformation, and the mechanical properties may be reduced.

The heat treatment temperature range in the heat treatment step S2 is more preferably from 400 to 800° C. and still more preferably from 450 to 780° C.

The heat treatment time in the heat treatment step S2 is preferably from 0.5 minutes to 10 hours. It is preferable to appropriately adjust the time according to the temperature, for example, to perform the treatment for a long time when the temperature is low or to perform the treatment for a short time when the temperature is high. In addition, it may be conducted by appropriately adjusting the heat treatment temperature and time according to the material state, for example, in the case of performing the heat treatment in a roll-to-roll or sheet form or in the case of performing the heat treatment in a coiled state.

Here, the resin component (binder resin component) or solvent contained in the slurry having dispersed therein a graphite powder is carbonized by this heat treatment and becomes almost an inorganic material and therefore, the carbon layer contains substantially no resin component and as a result, good conductivity can be obtained.

In addition, the heat treatment step S2 is performed in vacuum or under a non-oxidizing atmosphere such as Ar gas atmosphere. The non-oxidizing atmosphere in the heat treatment step S2 is an atmosphere having a low oxygen partial pressure and preferably an atmosphere having an oxygen partial pressure of 10 Pa or less. This is because, if it exceeds 10 Pa, the graphite becomes carbon dioxide by reacting with oxygen in the atmosphere (causes a combustion reaction), and the base material is oxidized and as a result, the conductivity is deteriorated.

### <Conductive Resin Layer Forming Step>

The conductive resin layer forming step S3 is a step of forming a conductive resin layer containing a carbon powder and a resin on/above the base material having formed thereon a carbon layer. In the conductive resin layer forming step S3, specifically, a conductive resin coating material is applied by lamination onto the surface of the carbon layer formed on the base material.

The conductive resin coating material may be prepared and used by dispersing the above-described carbon powder in a coating material containing the above-described resin (binder resin), such that the mass ratio of the resin solid content and the carbon powder falls in the above-described range.

The solvent of the conductive resin coating material is not particularly limited, and a known organic solvent, etc. may be used.

The method for applying the conductive resin coating material having dispersed therein a carbon powder onto the base material is not particularly limited, but the conductive resin coating material may be applied onto the carbon layer by using a bar coater, a roll coater, a gravure coater, a dip coater, a spray coater, etc.

### <Heat Treatment Step>

The heat treatment step S4 is a step of heat-treating the base material having formed thereon a carbon layer and a conductive resin layer (and an interlayer), at a predetermined temperature.

In the heat treatment step S4, the heat treatment is performed at 200 to 550° C. so as to more reduce the contact resistance of the conductive resin layer. In the case where the ratio of the resin component in the conductive resin layer is high, the contact resistance may be somewhat high. In such a case, when a heat treatment in a range of 200 to 550° C. is performed, the resin film covering the outermost surface of the conductive resin layer is partially decomposed and removed to expose the added carbon powder, and the conductivity in this portion is elevated.

If the heat treatment temperature is lower than 200° C., the effect of reducing the contact resistance is weak, and a long time is required to reduce the contact resistance to a target level. On the other hand, if the temperature exceeds 550° C., the effect of reducing the contact resistance is saturated and moreover, the decomposition of the conductive resin layer may excessively proceed, failing in obtaining the target abrasion resistance.

The range of the heat treatment temperature in the heat treatment step S4 is preferably a range of from 250 to 500° C. and more preferably a range of from 270 to 450° C.

As for the heat treatment atmosphere in the heat treatment step S4, the treatment can be conducted, for example, in an oxygen-containing atmosphere such as air atmosphere.

### <Press-Forming Step>

The press-forming step S5 is a step of shaping the base material to form a gas flow path.

The shaping of the base material in the press-forming step S5 may be performed by using a mold for shaping and by a known press-forming apparatus. Use or non-use of a lubricant during press-forming may be appropriately determined according to, e.g., the complexity of a target shape. In the case of performing the press-forming by using a lubricant, a treatment for removing the lubricant may be performed as part of the press-forming step.

### <<Order of Respective Steps>>

The order of the above-described respective steps in the method for producing a fuel cell separator material made of titanium according to the present invention is described in detail below.

In the case of producing a separator material having been subjected to press-forming, the production method of a separator material according to the present invention includes a case of proceeding in the order of as illustrated in FIG. 5, conductive resin layer forming step S3→press-forming step S5→heat treatment step S4, and a case of proceeding in the order of as illustrated in FIG. 6, press-forming step S5→conductive resin forming step S3→heat treatment step S4, after the carbon layer forming step S1 (and the heat treatment step S2).

In the case of the order illustrated in FIG. 5, the conductive resin layer forming step S3 is performed before the press-forming step S5, and thereby the conductive resin layer plays a role of a protective layer during press-forming in applying press-forming to the base material, so that separation/falling off of the carbon layer during press-forming can be avoided.

It may be anticipated that cracking occurs in the conductive resin layer depending on the degree of the press-forming step S5, and in such a case, the conductive resin layer forming step S3 may be again performed after the press-forming step S5.

In the case of the order illustrated in FIG. 6, the conductive resin layer forming step S3 is performed after the press-forming step S5. Even if the carbon layer cannot follow the deformation of the base material during press-forming and cracking of the carbon layer may be caused, since a conductive resin layer is thereafter formed as being laminated thereon, this layer can cover and protect the cracked portion of the carbon layer. As a result, the likelihood of separation/falling off of the carbon layer from the base material can be reduced.

In the foregoing pages, the embodiments of the present invention are described, but the present invention is not limited to these embodiments, and design changes can be appropriately made thereto without departing from the gist of the present invention as defined in the claims.

### Example 1

The fuel cell separator material made of titanium according to the present invention is specifically described below by comparing Examples satisfying the requirements of the present invention and Comparative Examples not satisfying the requirements of the present invention.

### <<Preparation of Specimen>>

### [Base Material]

As the base material, a base material of titanium of JIS Class 1 was used.

The chemical composition of the titanium base material (cold-rolling finished) contained O: 450 ppm, Fe: 250 ppm and N: 40 ppm, with the remainder being Ti and unavoidable impurities. The sheet thickness of the titanium base material was 0.1 mm and the size thereof was 50×150 mm. The titanium base material was obtained by subjecting a titanium raw material to conventionally known melting step, casting step, hot rolling step, and cold rolling step.

### [Carbon Layer]

An expanded graphite powder (SNE-6G, produced by SEC Carbon, Ltd., average particle diameter: 7 μm, purity: 99.9%) was used as the graphite powder, and a slurry was prepared by dispersing the graphite powder in an aqueous 0.8 wt % carboxymethyl cellulose solution to account for 8 wt %. The slurry was applied onto both surfaces of the titanium base material by using a bar coater having a count number of No. 10, No. 7 or No. 5 to prepare a graphite powder-coated material.

A roll-pressing was performed under a load of 2.5 tons by means of a two-high rolling mill with a work roll diameter of 200 mm and thereby the graphite powder was crushed and closely adhered onto the base material. Here, the work roll is not coated with lubricating oil.

The material having formed thereon a carbon layer was heat-treated in a vacuum atmosphere of 6.7×10⁻³ Pa at a temperature of 650° C. for 5 minutes.

The ones prepared by using a bar coater of No. 10 are Specimen Nos. 1-2 to 1-4, the ones prepared by using a bar coater of No. 7 are Specimen Nos. 1-5 to 1-8, and the ones prepared by using a bar coater of No. 5 are Specimen Nos. 1-9 to 1-13.

### [Conductive Resin Layer]

The conductive resin coating material was prepared by using coating materials of phenol resin (TAMANOL 2800, produced by Arakawa Chemical Industries, Ltd.), acrylic resin (COATAX LH681, produced by Toray Fine Chemicals Co., Ltd.), epoxy resin (EP106, produced by Cemedine Co., Ltd.), polyester resin (7005N, produced by Arakawa Chemical Industries, Ltd.), and silicone resin (KR251, produced by Shin-Etsu Silicones), and dispersing a carbon powder in each coating material. As the carbon powder, carbon black powder (VULCAN XC72, produced by Cabot Corporation, average particle diameter: 40 nm, purity: 99.2%) and graphite powder (Z-5F, produced by Ito Graphite Co., Ltd., average particle diameter: 4 μm, purity: 98.9%) were used.

The coating materials based on various resins were subjected to concentration adjustment by using an organic solvent suitable for each coating material such that a solid content (resin component+carbon powder) concentration (=((mass of resin component+mass of carbon powder)×100)/mass of coating material) in the coating material becomes about 18 mass %, the mass concentration (=(mass of carbon powder×100)/(mass of resin component+mass of carbon powder)) of the carbon powder in the solid content becomes about 25 mass %, and the ratio between carbon black powder and graphite powder becomes 10:1, and the coating material was applied by using a bar coater onto the material having formed thereon a carbon layer and dried. In this way, a conductive resin layer was formed on/above both surfaces of the base material. Here, specimens differing in the thickness of the conductive resin layer were prepared by changing the count number of the bar coater used.

[Heat Treatment after Formation of Conductive Resin Layer]

Some of specimens obtained by forming a conductive resin layer on a carbon layer were subjected to a heat treatment. The heat treatment was conducted by appropriately adjusting the treatment time under the condition of 200 to 400° C. in an air atmosphere.

### <<Evaluation of Specimen>>

### [Measurement of Coverage of Carbon Layer]

A region of 550×400 μm on the specimen surface having formed thereon a carbon layer was observed at an observation magnitude of 200 times by using a scanning electron microscope, and a reflected electron image thereof was taken. The reflected electron is image was binarized by image processing of dividing it into a portion covered by the carbon layer and a portion uncovered by the carbon layer to expose the base material, and the area percentage occupied by the carbon layer was calculated to determine the coverage. Observation was performed in 3 visual fields per 1 specimen, and an average of 3 visual fields was calculated.

### [Measurement of Thickness of Conductive Resin Layer]

The material thickness before and after forming a conductive resin layer on a specimen having formed thereon a carbon layer was measured by using a micrometer, and the thickness of the conductive resin layer was calculated from the difference in thickness between therebefore and thereafter. The measurement of thickness was performed at 3 points per 1 specimen, and an average of 3 points was calculated.

### [Measurement of Contact Resistance]

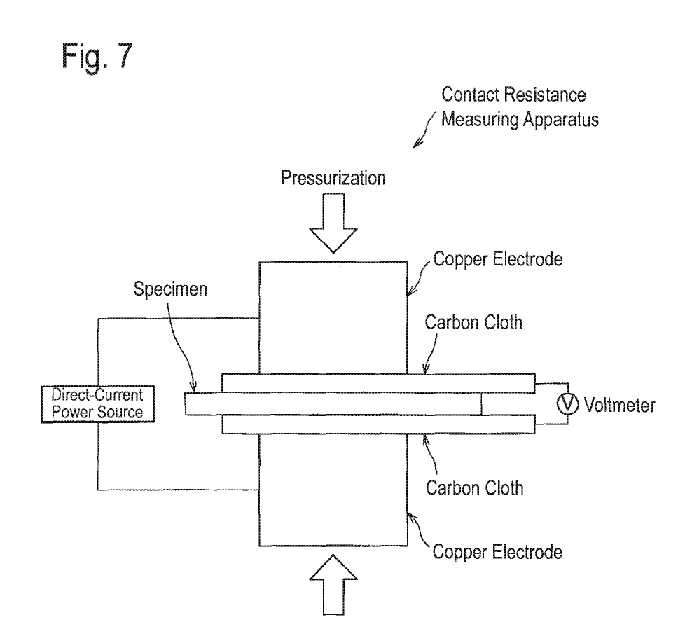

Each of the specimens obtained was measured for the contact resistance by using the contact resistance measuring apparatus illustrated in FIG. 7. In detail, both surfaces of the specimen were sandwiched between two sheets of carbon paper, the outer sides thereof were further sandwiched between two sheets of copper electrode having a contact area of 1 cm² and pressurized under a load of 10 kgf, a current of 7.4 mA was flowed therethrough by using a direct-current power source, and a voltage applied between carbon paper sheets was measured by a voltmeter to determine the contact resistance (initial contact resistance).

The conductivity was judged as good when the initial contact resistance was 12 mΩ·cm² or less and the conductivity was judged as bad when more than 12 mΩ·cm².

### [Durability Evaluation]

With respect to the specimen of which initial contact resistance was judged as passed, durability evaluation (durability test) was performed. That is, the specimen was subjected to an immersion treatment in an aqueous sulfuric acid solution (pH: 2) having a specific liquid volume of 10 ml/cm² at 80° C. for 500 hours, and thereafter, the specimen was taken out from the aqueous sulfuric acid solution, washed, dried and measured for the contact resistance by the same method as above.

The durability was judged as passed when the contact resistance after the durability test was 15 mΩ·cm² or less and the durability was judged as failed when more than 15 mΩ·cm².

### [Adhesiveness Evaluation]

A tape (mending tape produced by Sumitomo 3M, 12 mm-wide) was adhered to the carbon-based conductive layer surface of the specimen and the tape was then peeled off in a direction perpendicular to the specimen surface, whereby the adhesiveness of the carbon-based conductive layer was evaluated.

The evaluation criteria of adhesiveness were “AA” when the adhesive of the tape remained on the carbon-based conductive layer surface; “A” when the carbon-based conductive layer was slightly transferred to the tape side; “B” when separation occurred in the carbon-based conductive layer; and “C” when the carbon-based conductive layer was separated in the interface with the base material. Rating of “A” or higher was judged as passed.

### [Evaluation of Abrasion Resistance]

The abrasion resistance of the carbon-based conductive layer was evaluated by also using the contact resistance measuring apparatus used in the evaluation of contact resistance (see, FIG. 7). Although the contact area of the copper electrode was 1 cm² in contact resistance evaluation, this evaluation was performed by using a copper electrode having a contact area of 4 cm². The specimen prepared were sandwiched from both surfaces thereof, between two sheets of carbon cloth, the outer sides thereof were further pressurized by copper electrodes each having a contact area of 4 cm² under a contact load of 40 kgf, and while keeping applying a pressure on both surfaces, the specimen was pulled out in the plane direction (pull-out test). After the pull-out test, the sliding region on the specimen surface was observed by an optical microscope, and evaluation was performed by the remaining state of the conductive layer, i.e., the degree of exposure of the base material.

The judgment criteria of abrasion resistance were “AA” when exposure of the base material on the specimen surface was not observed at all; “A” when the percentage of area of the base material exposed on the specimen surface was less than 30%; “B” when the percentage of area of the base material exposed on the specimen surface was less than 50%; and “C” when the percentage of area of the base material exposed was 50% or more. Rating of “A” or higher was judged as passed.

### [Configuration and Elemental Composition Analysis of Interlayer]

The cross-section of the surface layer of each specimen was sample-processed by an ion beam processing apparatus (Hitachi Focused Ion Beam System, FB-2100), then the cross-section was observed at a magnification of 750,000 times by a transmission electron microscope (TEM; Hitachi Field Emission Electron Microscope, HF-2200) to confirm the presence of an interlayer at the interface between the carbon layer and the titanium base material, and EDX analysis and electron diffraction analysis were performed at an arbitrary point in the interlayer to determine whether titanium carbide was present or not.

The coverage of the carbon layer, the presence or absence of titanium carbide in the interlayer, the kind of resin and the thickness of the conductive resin layer, the conditions of heat treatment after forming the conductive resin layer, the contact resistance in the initial stage and after durability test, and the evaluation results of adhesiveness and abrasion resistance are shown in Table 1.

TABLE 1

| | | | | | Heat Treatment | | | | | | |
|---|---|---|---|---|---|---|---|---|---|---|---|
| | Coverage | | | | Conditions After | | Contact Resistance | | | | |
| | of | | | | Forming Conductive | | (mΩ · cm²) | | | | |
| | Carbon | | Conductive Resin Layer | | Resin Layer | | | After | | | |
| Specimen | Layer | Inter- | Kind | Thickness | Temperature | Time | Initial | Durability | Adhesive- | Abrasion | |
| No. | (%) | layer | of Resin | (μm) | (° C.) | (sec) | Stage | Test | ness | Resistance | |
| 1-1 | 0 | absent | phenol resin | 5 | 400 | 60 | 64 | — | AA | A | Comparative |
| 1-2 | 100 | present | — | — | — | — | 2.3 | 2.4 | B | B | Example |
| 1-3 | 100 | present | phenol resin | 15 | 300 | 120 | 11.3 | 13.8 | AA | AA | Comparative |
| 1-4 | 100 | present | phenol resin | 10 | — | — | 10 | 11.2 | AA | AA | Example |
| 1-5 | 80 | present | acrylic resin | 3 | — | — | 4.5 | 4.9 | AA | AA | Example |
| 1-6 | 80 | present | phenol resin | 3 | 200 | 180 | 10.8 | 12 | AA | AA | Example |
| 1-7 | 80 | present | phenol resin | 3 | 400 | 45 | 5.2 | 5.5 | AA | AA | Example |
| 1-8 | 80 | present | epoxy resin | 3 | 400 | 60 | 6.4 | 7.2 | AA | AA | Example |
| 1-9 | 60 | present | polyester resin | 3 | — | — | 9.2 | 10.5 | AA | AA | Example |
| 1-10 | 60 | present | polyester resin | 3 | 300 | 60 | 6.1 | 6.8 | AA | AA | Example |
| 1-11 | 60 | present | silicone resin | 3 | — | — | 9.2 | 10.5 | A | AA | Example |
| 1-12 | 60 | present | silicone resin | 3 | 400 | 60 | 5.9 | 6.3 | A | AA | Example |
| 1-13 | 60 | present | silicone resin | 1 | 400 | 60 | 4.8 | 5.3 | A | A | Example |

Since Specimen No. 1-1 was one in which a carbon layer was not present and a conductive resin layer was formed directly on a pure titanium base material, the result was that the conductivity was insufficient. Since Specimen No. 1-2 was one in which only one layer of a carbon layer was formed as the carbon-based conductive layer, the result was that the conductivity and durability were very excellent, but the adhesiveness and abrasion resistance were insufficient.

On the other hand, in Specimen Nos. 1-3 to 1-13 where a conductive resin layer is formed on a carbon layer within the range specified in the present invention, all of the conductivity, durability, adhesiveness, and abrasion resistance were in the acceptance range. Above all, out of specimens where a heat treatment was performed after forming the conductive resin layer, in Specimen Nos. 1-7, 1-8, 1-10, 1-12, and 1-13, contact resistance showed a low value, revealing that the conductivity and durability were very excellent.

### Example 2

Test pieces of 20×65 mm were prepared from “Specimen No. 1-3” where the coverage of the carbon layer on the base material was 100%, “Specimen No. 1-7” where it was 80%” and “Specimen No. 1-10” where it was 60% and after performing stretch processing by using these, simulating a material elongation part during press-forming process, the abrasion resistance and adhesiveness of the carbon-based conductive layer in the elongation part were evaluated.

### [Stretch Processing]

The stretch processing was performed by using a small-size tensile tester. Lines were drawn (distance between lines: 25 mm) at a portion of 20 mm from both ends of the test piece and after fixing both ends of the test piece with a chuck of the tester, followed by processing at a tensile speed of 5 min/min until the distance between lines became 31 mm (average material elongation: 25%) to obtain a stretch processing specimen. Thereafter, the adhesiveness and abrasion resistance of the carbon-based conductive layer in the stretch processed part were evaluated by the same means as in Example 1, and ratings of “AA”, “A”, “B”, and “C” were determined based on the same criteria. Here, since this evaluation is more severe evaluation than the evaluation of Example 1, rating of “B” or higher was judged as passed. The results are shown in Table 2,

TABLE 2

| | | | | | Heat Treatment | | | | | |
|---|---|---|---|---|---|---|---|---|---|---|
| | | | | | Conditions After | | | | | |
| | Coverage | | | | Forming Conductive | | | | | |
| | of Carbon | | Conductive Resin Layer | | Resin Layer | | | After Stretch Processing | | |
| Specimen | Layer | Inter- | Kind | Thickness | Temperature | Time | Stretch | Adhesive- | Abrasion | |
| No. | (%) | layer | of Resin | (μm) | (° C.) | (sec) | Processing | ness | Resistance | |
| 1-3 | 100 | present | phenol resin | 15 | 300 | 120 | done | B | A | Example |
| 1-7 | 80 | present | phenol resin | 3 | 400 | 45 | done | A | AA | Example |
| 1-10 | 60 | present | polyester resin | 3 | 300 | 60 | done | AA | AA | Example |

As shown in Table 2, as to Specimen Nos. 1-3, 1-7 and 1-10, both the adhesiveness and the abrasion resistance of the carbon-based conductive layer were good in the state before stretch processing.

However, when stretch processing envisaging a material elongation part due to press-forming process was performed, as to Specimen No. 1-3 having a carbon layer coverage of 100%, the adhesiveness and abrasion resistance clearly showed a tendency to decrease. On the other hand, as to No. 1-7 having a carbon layer coverage of 80%, a significant reduction was not observed in the abrasion resistance, though the adhesiveness was slightly reduced, and as to No. 1-10 having a carbon layer coverage of 60%, a significant reduction was not observed in both the adhesiveness and the abrasion resistance.

### Example 3

### Preparation of Specimen

### [Base Material]

As the base material, a base material of titanium of JIS Class 1 was used.

The chemical composition of the titanium base material (cold-rolling finished) contained O: 450 ppm, Fe: 250 ppm and N: 40 ppm, with the remainder being Ti and unavoidable impurities. The sheet thickness of the titanium base material was 0.1 mm and the size thereof was 80×160 mm. The titanium base material was obtained by subjecting a titanium raw material to conventionally known melting step, casting step, hot rolling step, and cold rolling step.

### [Carbon Layer]

An expanded graphite powder (SNE-6G, produced by SEC Carbon, Ltd., average particle diameter: 7 μm, purity: 99.9%) was used as the graphite powder, and a slurry was prepared by dispersing the graphite powder in an aqueous 0.7 wt % carboxymethyl cellulose solution to account for 7 wt %. The slurry was applied onto both surfaces of the titanium base material by using a bar coater having a count number of No. 5 to prepare a graphite powder-coated material.

A roll-pressing was performed under a load of 2.5 tons by means of a two-high rolling mill with a work roll diameter of 200 mm and thereby the graphite powder was crushed and closely adhered onto the base material. Here, the work roll is not coated with lubricating oil.

The material having formed thereon a carbon layer was heat-treated in a vacuum atmosphere of 6.7×10⁻³ Pa at a temperature of 650° C. for 5 minutes.

The coverage of the carbon material of the specimen obtained by this method was about 60%.

### [Conductive Resin Layer]

The conductive resin coating material was prepared by using coating materials of phenol resin (TAMANOL 2800, produced by Arakawa Chemical Industries, Ltd.), acrylic resin (COATAX LH681, produced by Toray Fine Chemicals Co., Ltd.), epoxy resin (EP106, produced by Cemedine Co., Ltd.), polyester resin (7005N, produced by Arakawa Chemical Industries, Ltd.), and silicone resin (KR251, produced by Shin-Etsu Silicones), and dispersing a carbon powder in each coating material. As the carbon powder, carbon black powder (VULCAN XC72, produced by Cabot Corporation, average particle diameter: 40 nm, purity: 99.2%) and graphite powder (Z-5F, produced by Ito Graphite Co., Ltd., average particle diameter: 4 μm, purity: 98.9%) were used.

The coating materials based on various resins were subjected to concentration adjustment by using an organic solvent suitable for each coating material such that a solid content (resin component+carbon powder) concentration (=((mass of resin component+mass of carbon powder)×100)/mass of coating material) in the coating material becomes about 18 mass %, the mass concentration (=(mass of carbon powder×100)/(mass of resin component+mass of carbon powder)) of the carbon powder in the solid content becomes about 25 mass %, and the ratio between carbon black powder and graphite powder becomes 10:1, and the coating material was applied by using a bar coater onto the material having formed thereon a carbon layer and dried. In this way, a conductive resin layer was formed on/above both surfaces of the base material. Here, specimens differing in the thickness of the conductive resin layer were prepared by changing the count number of the bar coater used.

### [Press-Forming]

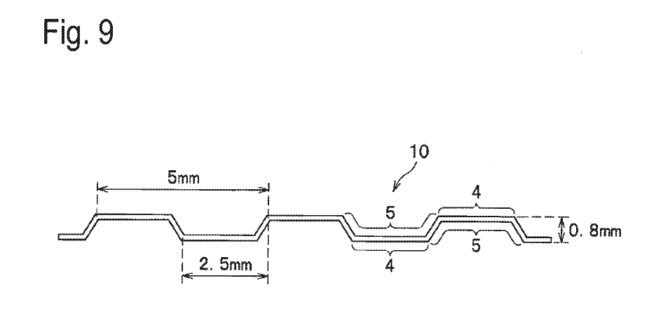

The base material having formed on/above the surface thereof a carbon layer and a conductive resin layer was cut out into a size of 50 mm×50 mm and shaped as in FIG. 9 by press-forming in a mold.

[Heat Treatment after Formation of Conductive Resin Layer]

Some of specimens obtained by performing press-forming after the formation of a conductive resin layer were subjected to a heat treatment. The heat treatment was conducted by appropriately adjusting the treatment time under the condition of 300 to 400° C. in an air atmosphere.

### <<Evaluation of Specimen>>

### [Measurement of Coverage of Carbon Layer]

A region of 550×400 μm on the specimen surface having formed thereon a carbon layer was observed at an observation magnitude of 200 times by using a scanning electron microscope, and a reflected electron image thereof was taken. The reflected electron image was binarized by image processing of dividing it into a portion covered by the carbon layer and a portion uncovered by the carbon layer to expose the base material, and the area percentage occupied by the carbon layer was calculated to determine the coverage. Observation was performed in 3 visual fields per 1 specimen, and an average of 3 visual fields was calculated.

### [Measurement of Thickness of Conductive Resin Layer]

The material thickness before and after forming a conductive resin layer on a specimen having formed thereon a carbon layer was measured by using a micrometer, and the thickness of the conductive resin layer was calculated from the difference in thickness between therebefore and thereafter. The measurement of thickness was performed at 3 points per 1 specimen, and an average of 3 points was calculated.

### [Measurement of Contact Resistance]

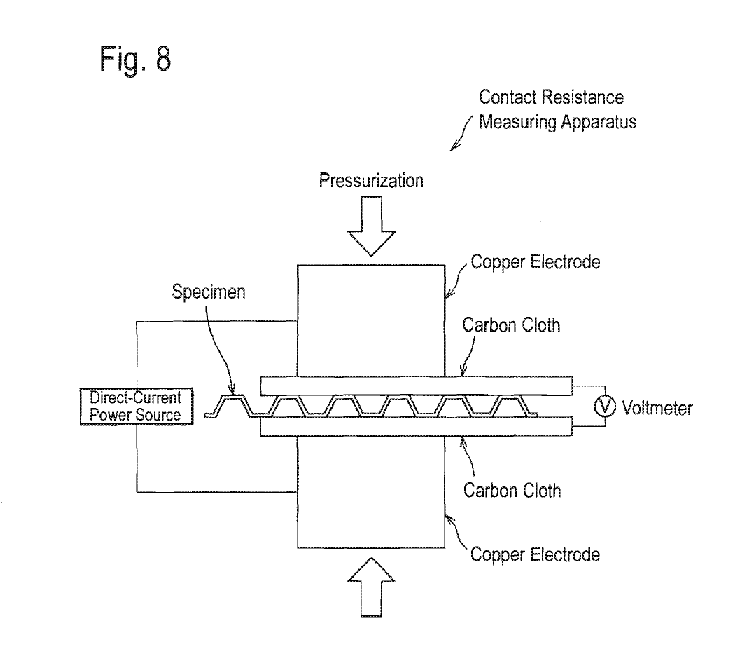

Each of the specimens obtained was measured for the contact resistance by using the contact resistance measuring apparatus illustrated in FIG. 8. In detail, both surfaces of the specimen were sandwiched between two sheets of carbon paper, the outer sides thereof were further sandwiched between two sheets of copper electrode having a contact area of 4 cm² and pressurized under a load of 40 kgf, a current of 7.4 mA was flowed therethrough by using a direct-current power source, and a voltage applied between carbon paper sheets was measured by a voltmeter to determine the contact resistance (initial contact resistance) assuming that the contact area is ⅖ of that of a flat plate.

The conductivity was judged as good when the initial contact resistance was 12 mΩ·cm² or less and the conductivity was judged as bad when more than 12 mΩ·cm².

### [Durability Evaluation]

With respect to the specimen of which initial contact resistance was judged as passed, durability evaluation (durability test) was performed. That is, the specimen was subjected to an immersion treatment in an aqueous sulfuric acid solution (pH: 2) having a specific liquid volume of 10 ml/cm² at 80° C. for 500 hours, and thereafter, the specimen was taken out from the aqueous sulfuric acid solution, washed, dried and measured for the contact resistance by the same method as above.

The durability was judged as passed when the contact resistance after the durability test was 15 mΩ·cm² or less and the durability was judged as failed when more than 15 mΩ·cm².

### [Evaluation of Abrasion Resistance]

The abrasion resistance of the carbon-based conductive layer was evaluated by also using the contact resistance measuring apparatus used in the evaluation of contact resistance (see, FIG. 8). The specimen prepared were sandwiched from both surfaces thereof, between two sheets of carbon cloth; the outer sides thereof were further pressurized by copper electrodes each having a contact area of 4 cm² under a contact load of 40 kgf, and while keeping applying a pressure on both surfaces, the specimen was pulled out in a direction parallel to the groove direction (pull-out test). After the pull-out test, the sliding region on the specimen surface was observed by an optical microscope, and evaluation was performed by the remaining state of the carbon-based conductive layer, i.e., the degree of exposure of the base material.

The judgment criteria of abrasion resistance were “AA” when exposure of the base material on the surface in a groove convex region (a planar part 4 on the outer surface of a gas flow path) of the specimen was not observed at all and exposure was not observed also in an R part; “A” when exposure of the base material on the surface in a groove convex region of the specimen was not observed at all but exposure of the base material was slightly observed in the R part; “B” when the percentage of area of the base material exposed on the surface in a groove convex region of the specimen was less than 50%; and “C” when the percentage of area of the base material exposed was 50% or more. Rating of “A” or higher was judged as passed.

The kind of resin and the thickness of the conductive resin layer, the conditions of heat treatment after forming the conductive resin layer, the contact resistance in the initial stage and after durability test, and the evaluation results of abrasion resistance are shown in Table 3.

TABLE 3

| | | | Heat Treatment | | | | | |
|---|---|---|---|---|---|---|---|---|
| | | | Conditions After | | Contact Resistance | | | |
| | Conductive Resin Layer | | Forming Conductive | | (mΩ · cm²) | | | |
| Specimen | Kind | Thickness | Temperature | Time | | After Durability | Abrasion | |
| No. | of Resin | (μm) | (° C.) | (sec) | Initial Stage | Test | Resistance | |
| 2-1 | — | — | — | — | 3.2 | 12.3 | C | Comparative |
| | | | | | | | | Example |
| 2-2 | phenol resin | 3 | — | — | 11 | 12.8 | A | Example |
| 2-3 | phenol resin | 3 | 300 | 120 | 8.6 | 10.1 | A | Example |
| 2-4 | phenol resin | 3 | 400 | 45 | 6.2 | 7.4 | A | Example |
| 2-5 | acrylic resin | 5 | — | — | 6.1 | 7.5 | A | Example |
| 7-6 | polyester resin | 3 | — | — | 10.5 | 12.3 | A | Example |
| 2-7 | polyester resin | 3 | 300 | 60 | 7.2 | 9.1 | A | Example |
| 2-8 | silicone resin | 3 | — | — | 10.3 | 13.2 | A | Example |
| 2-9 | silicone resin | 3 | 400 | 60 | 6.2 | 8.2 | A | Example |

In Specimen No. 2-1 which only has a carbon layer, the result was that the initial conductivity was excellent, but the contact resistance value was extremely elevated, though the durability was in the acceptance range, and the abrasion resistance was insufficient.

On the other hand, in Specimen Nos. 2-2 to 2-9 which were produced by the method specified in the present invention, all of the conductivity, durability and abrasion resistance were in the acceptance range also after press-forming. Among others, in Specimen Nos. 2-3, 2-4, 2-7, and 2-9 where a heat treatment was performed after forming the conductive resin layer, contact resistance showed a low value and the durability was also good, revealing that these are preferred.

### Example 4

### Preparation of Specimen

By using the same method and materials as in Example 3, a carbon layer having a coverage of about 60% was formed on a pure titanium base material and subjected to a heat treatment, and after press-forming the material, a conductive resin layer was formed on both surfaces by the following method.

### [Conductive Resin Layer]

The conductive resin coating material was prepared by using coating materials of phenol resin (TAMANOL 2800, produced by Arakawa Chemical Industries, Ltd.), acrylic resin (COATAX LH681, produced by Toray Fine Chemicals Co., Ltd.), epoxy resin (EP106, produced by Cemedine Co., Ltd.), polyester resin (7005N, produced by Arakawa Chemical Industries, Ltd.), and silicone resin (KR251, produced by Shin-Etsu Silicones), and dispersing a carbon powder in each coating material. As the carbon powder, carbon black powder (VULCAN XC72, produced by Cabot Corporation, average particle diameter: 40 nm, purity: 99.2%) and graphite powder (Z-5F, produced by Ito Graphite Co., Ltd., average particle diameter: 4 μm, purity: 98.9%) were used.

The coating materials based on various resins were subjected to concentration adjustment by using an organic solvent suitable for each coating material such that a solid content (resin component+carbon powder) concentration (=((mass of resin component+mass of carbon powder)×100)/mass of coating material) in the coating material becomes about 18 mass %, the mass concentration (=(mass of carbon powder×100)/(mass of resin component+mass of carbon powder)) of the carbon powder in the solid content becomes about 40 mass %, and the ratio between carbon black powder and graphite powder becomes 4:1, and the coating material was applied by spraying onto the material after press-forming and dried. In this way, a conductive layer was formed on both surfaces of the material after press-forming to prepare various specimens.

[Heat Treatment after Formation of Conductive Resin Layer]

Some of specimens obtained by forming a conductive resin layer after press-forming were subjected to a heat treatment. It was conducted by appropriately adjusting the treatment time under the condition of 400° C. by using an atmospheric heat treatment.

### <<Evaluation of Specimen>>

Evaluations of initial contact resistance, durability and abrasion resistance were conducted by the same method as in Example 3.

As for the thickness of the conductive resin layer after applying by spraying the conductive resin coating material, part of the material was embedded in a resin, followed by cross-sectional processing, and the thickness of the resin was measured at a point expected to be average in the visual field through SEM observation from the cross-section. The cross-sectional observation was performed in 3 visual fields per 1 specimen and an average of 3 visual fields was calculated.

The kind of resin and the thickness of the conductive resin layer, the conditions of heat treatment after forming the conductive resin layer, the contact resistance in the initial stage and after durability test, and the evaluation results of abrasion resistance are shown in Table 4.

TABLE 4

| | | | Heat Treatment | | | | | |
|---|---|---|---|---|---|---|---|---|
| | | | Conditions After | | Contact Resistance | | | |
| | Conductive Resin Layer | | Forming Conductive | | (mΩ · cm²) | | | |
| Specimen | | Thickness | Temperature | Time | | After Durability | Abrasion | |
| No. | Kind of Resin | (μm) | (° C.) | (sec) | Initial Stage | Test | Resistance | |
| 2-10 | phenol resin | 2 | — | — | 103 | 12.3 | AA | Example |
| 2-11 | phenol resin | 2 | 400 | 45 | 5.2 | 6.4 | AA | Example |
| 2-12 | acrylic resin | 2 | — | — | 5.5 | 6.8 | AA | Example |
| 2-13 | polyester resin | 3 | — | — | 9.8 | 12.8 | AA | Example |
| 2-14 | polyester resin | 3 | 400 | 60 | 6.3 | 7.5 | AA | Example |
| 2-15 | silicone resin | 1 | — | — | 11.5 | 13.2 | AA | Example |
| 2-16 | silicone resin | 1 | 400 | 60 | 7.3 | 8.3 | A | Example |

In Specimen Nos. 2-10 to 2-16 which were prepared by the method specified in the present invention, all of the conductivity, durability and abrasion resistance were in the acceptance range also after press-forming. In the ones where a conductive resin layer was formed after press-forming, a very good result was obtained as to the abrasion resistance.

### DESCRIPTION OF REFERENCE NUMERALS AND SIGNS

1 Base material
2 Carbon-based conductive layer
3 Interlayer
10, 10a and 10b Fuel cell separator material made of titanium (separator material)
21 Carbon layer
22 Conductive resin layer
S1 Carbon layer forming step
S2 Heat treatment step
S3 Conductive resin layer forming step
S4 Heat treatment step
S5 Press-forming step

1: A fuel cell separator material made of titanium, having a carbon-based conductive layer formed on a surface of a base material comprising pure titanium or a titanium alloy, wherein:
the carbon-based conductive layer has a two-layer structure, and in the carbon-based conductive layer, a layer on a side closer to the base material is a carbon layer and a layer on a side farther from the base material is a conductive resin layer;
the carbon layer comprises graphite and the carbon layer has a coverage of 40% or more; and
the conductive resin layer comprises a carbon powder and a resin and the resin is one or more resins selected from the group consisting of an acrylic resin, a polyester resin, an alkyd resin, a urethane resin, a silicone resin, a phenol resin, an epoxy resin, and a fluororesin.

2: The fuel cell separator material made of titanium according to claim 1, wherein the carbon layer has the coverage of 40% or more and 80% or less.

3: The fuel cell separator material made of titanium according to claim 1, having an interlayer comprising titanium carbide, the interlayer being formed between the base material and the carbon layer.

4: The fuel cell separator material made of titanium according to claim 3, wherein the conductive resin layer has a thickness of from 0.1 to 20 μm.

5: A method for producing a fuel cell separator material made of titanium, comprising:
a carbon layer forming step of forming a carbon layer comprising graphite on a surface of a base material comprising pure titanium or a titanium alloy; and
a conductive resin layer forming step of, after the carbon layer forming step, forming a conductive resin layer comprising a carbon powder and a resin on/above the base material having formed thereon the carbon layer,
wherein:
the carbon layer has a coverage of 40% or more; and
the resin of the conductive resin layer is one or more resins selected from the group consisting of an acrylic resin, a polyester resin, an alkyd resin, a urethane resin, a silicone resin, a phenol resin, an epoxy resin, and a fluororesin.

6: The method for producing a fuel cell separator material made of titanium according to claim 5, wherein the carbon layer has the coverage of 40% or more and 80% or less.

7: The method for producing a fuel cell separator material made of titanium according to claim 5, further comprising a heat treatment step of heat-treating the base material at 200 to 550° C., after the conductive resin layer forming step.

8: The method for producing a fuel cell separator material made of titanium according to claim 7, further comprising a heat treatment step of heat-treating the base material at 300 to 850° C. under a non-oxidizing atmosphere, between the carbon layer forming step and the conductive resin layer forming step.

9: The method for producing a fuel cell separator material made of titanium according to claim 5, further comprising:
a press-forming step of, after the conductive resin layer forming step, press-forming the base material on/above which the carbon layer and the conductive resin layer have been formed, to form a gas flow path.

10: The method for producing a fuel cell separator material made of titanium according to claim 9, wherein the carbon layer has the coverage of 40% or more and 80% or less.

11: The method for producing a fuel cell separator material made of titanium according to claim 9, further comprising a heat treatment step of heat-treating the base material at 200 to 550° C., after the press-forming step.

12: The method for producing a fuel cell separator material made of titanium according to claim 11, further comprising a heat treatment step of heat-treating the base material at 300 to 850° C. under a non-oxidizing atmosphere, between the carbon layer forming step and the conductive resin layer forming step.

13: A method for producing a fuel cell separator material made of titanium, comprising:
a carbon layer forming step of forming a carbon layer comprising graphite on a surface of a base material comprising pure titanium or a titanium alloy;
a press-forming step of after the carbon layer forming step, press-forming the base material having formed thereon the carbon layer to form a gas flow path; and
a conductive resin layer forming step of, after the press-forming step, forming a conductive resin layer comprising a carbon powder and a resin on/above the base material having formed thereon the carbon layer and having press-formed,
wherein:
the carbon layer has a coverage of 40% or more; and
the resin of the conductive resin layer is one or more resins selected from the group consisting of an acrylic resin, a polyester resin, an alkyd resin, a urethane resin, a silicone resin, a phenol resin, an epoxy resin, and a fluororesin.

14: The method for producing a fuel cell separator material made of titanium according to claim 13, wherein the carbon layer has the coverage of 40% or more and 80% or less.

15: The method for producing a fuel cell separator material made of titanium according to claim 13, further comprising a heat treatment step of heat-treating the base material at 200 to 550° C., after the conductive resin layer forming step.

16: The method for producing a fuel cell separator material made of titanium according to claim 5, further comprising a heat treatment step of heat-treating the base material at 300 to 850° C. under a non-oxidizing atmosphere, between the carbon layer forming step and the press-forming step.
